(19) United States
(12) Patent Application Publication
(10) Pub. No.: US 2006/0118623 A1
(43) Pub. Date: Jun. 8, 2006

(54) Card reader

(76) Inventor: Yasuhira Kitazawa, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/288,633

(22) Filed: Nov. 29, 2005

(30) Foreign Application Priority Data
Nov. 30, 2004 (JP) 2004-347460

(51) Int. Cl. G06K 7/00

(52) U.S. Cl. 235/436

(57) ABSTRACT

The present invention provides a card reader in which a card transfer system operated by motor-driven rotations transfers a card medium to a given position where card data is readout and written. A time measurement means measures the startup time, which is the time it takes for the motor to reach a steady rotation speed after it is turned on is. A judgment means judges whether the card transfer system is operating under normal or abnormal conditions by way of comparing a regulated startup time set in advance with the actual startup time obtained from the time measurement means to detect if the actual startup time remains within the allowable range of the regulated startup time. Hence, the correct judgment that the card transfer system is in abnormal conditions can be made.

### CROSS-REFERENCE TO RELATED APPLICATIONS

This application claims priority to Japanese Application No. 2004-347460 filed Nov. 30, 2004, which is incorporated herein by reference.

### FIELD OF THE INVENTION

The present invention relates to a card reader which reads out data recorded on a card type data storage medium such as a credit card (hereinafter referred to as “card medium”). More specifically, it relates to a card reader equipped with a function to self-diagnose any abnormality in the card transfer system.

### BACKGROUND OF THE INVENTION

Generally, a card reader installed in an ATM (Automatic Transaction Machine) or vending machine is an apparatus which reads out and writes data on a card medium inserted from a card insertion slot. In the card reader of this type, if it is detected that the card medium inserted from the card insertion slot is appropriate, a shutter is opened to take the card medium into the card reader. After the shutter is opened, a motor, the drive source, is actuated to operate a card transfer system to transfer the card medium along the card transfer system. The position of the card medium is continued to be detected by a medium sensor during the transfer until the card medium reaches a head for readout or writing of card data to execute a card transaction.

Now, whether the motor is operating in response to a normal load transmitted from the card transfer system must be monitored. In other words, the card medium is transferred to the position where card data is readout or written correctly, and the correct readout and writing is actualized if the motor rotates normally in response to a normal load. However, if belts or rollers in the card transfer system are damaged or deteriorated because of extended periods of use, for example, when deposition of dust or contaminated lubricant occurs around the rotary shaft, a load which is larger than normal is applied to the motor. Conversely, when a belt is broken the load is reduced.

As described above, even though the card medium inserted from the card insertion port is an appropriate one, the length or size of the card is read incorrectly if the card transfer system is in abnormal conditions. As a result, a misjudgment that the card is fraudulent occurs; this is a problem.

For this reason, in order to detect an abnormality of the card transfer system, after the motor starts up and rotates at a steady-state speed with about constant revolutions, the card reader described in the Japanese Patent No. 2784875, compares the actual revolutions, which are measured within a predetermined duration, with the regulating revolutions, which are previously set as an appropriate value, and judges whether the motor is driven at an appropriate rotation speed.

Normally, in a card reader, a control circuit is configured such that revolutions of a motor remain constant. So, even if components of a card transfer system are deteriorated or a belt is broken, the above-mentioned control circuit operates after the rotation speed of a motor reaches the steady state or about constant revolutions after actuation. Accordingly, the motor rotates as if it operates under normal conditions; this is a problem.

The objective of the present invention is to provide a card reader which can correctly judge the presence or absence of an abnormality of a card transfer system.

### SUMMARY OF THE INVENTION

To achieve the above objective, the present invention provides a card reader in which a card transfer system operated by motor-driven rotations transfers a card medium to a given position where card data is readout and written characterized in that it comprises a time measurement means for measuring the startup time, which is the time it takes for the motor to reach a steady rotation speed after it is turned on; and it also comprises a judgment means for judging whether the card transfer system is operating under normal or abnormal conditions by way of comparing a regulated startup time set in advance with the actual startup time, which is obtained from the time measurement means to detect if the actual startup time remains within the allowable range of the regulated startup time, and by way of further deciding if the motor is operated under a normal or abnormal load using the result of the decision.

According to the present invention, if the actual startup time, which is the time it takes for the motor to reach a steady speed of steady revolutions, remains within the allowable range of the regulated startup time, the judgment means judges that the motor load is normal and there is no abnormality in the card transfer system.

If the actual startup time exceeds the regulated startup time, the judgment means judges that the motor load is larger than that of normal conditions and that this situation arises because the card transfer system is in abnormal conditions.

As a result, once it is judged that an abnormality occurs in the card transfer system, an erroneous reading of the information or size of the card, which causes a legitimate card medium inserted into the card insertion port by a customer to be judged as a fraudulent card, can be corrected. Hence, the correct judgment that the card transfer system is in abnormal conditions can be made.

Furthermore, in the present invention, it is preferable for the card reader that a control system including the time measurement means and the judgment means be communicably connected to an upper level apparatus such that whether the motor and the card transfer system operate in abnormal conditions is judged in accordance with an abnormality diagnostic program initialized by the initialization command received from the upper level apparatus.

According to the present invention, the card reader is connected to, for example, a higher level apparatus such that whether the motor and card transfer system is in abnormal conditions can be judged based on the diagnostic program initialized by the initialization command.

For this reason, if the card reader is installed at branches of financial institutions such as banks, this diagnostic program, which is stored in the upper level apparatus and to be initialized by the initialization command, enables the card reader to always check an abnormality of the motor and card transfer system upon transmission of the initialization command to the target card reader outside of their business hours. The trouble in which the card medium of a customer is misjudged as a fraudulent card is thus resolved. In addition, maintenance service and management required for card transactions can thus be operated smoothly.

Moreover, in the present invention, it is preferable that the card reader comprises a memory for memorizing the regulated startup time and storing the judgment results on normality or abnormality of the transfer system as a history, and also comprises a display means for notifying the results by displaying it on a screen.

According to the present invention, if an abnormality of the card transfer system is detected, the card reader warns those around it of the termination of the subsequent card transaction by displaying the abnormal incident message, for example, on the monitor screen in the upper level. In other words, displaying the warning that the card transfer system is in abnormal conditions on the monitor screen in the upper level apparatus expedites the corrective response to the card reader.

Furthermore, in the present invention, it is desirable that the card reader, in which a card transfer system is operated by motor-driven rotations to transfer a card medium to a given position where card data is readout and written, comprises a time measurement means for measuring the time required for the motor output shaft to stop rotating after the motor drive is turned off as the actual drive-off time; and it also comprises a judgment means for judging if the transfer system is operating under normal or abnormal conditions. The judgment is made by comparing a predetermined regulated drive-off time with the actual drive-off time obtained from the time measurement means so as to detect if the actual drive-off time remains within the allowable range of the regulated drive-off time, and then deciding if the motor is operating at a normal load or abnormal load.

Alternatively, instead of measuring the actual startup time after the motor is actuated, in the present invention, the card reader may measure an actual drive-off time, which is the time required for the motor output shaft to stop rotating after it is turned off, and may also judge that the motor load is normal and the card transfer system is in normal conditions if the actual drive-off time is within the allowable range of the drive-off regulated time. If the actual drive-off time exceeds the regulated drive-off time, the judgment means judges that the motor load is larger than normal, and also judges that the motor load is excessive because an abnormality occurs in the card transfer system. The abnormal conditions of the motor and card transfer system should be checked.

The use of this method enables monitoring abnormal conditions of the motor and card transfer system by means of detecting the actual drive-off time, which is the time required for the motor output shaft to stop rotating after the motor drive is turned off. Accordingly, a degree of freedom can be obtained for the abnormality diagnosing function.

In the present invention, the card reader makes a judgment utilizing a diagnosing function of a time measurement means or judgment means, which determines whether the measurement of startup time, which is the time required for a motor to reach a steady speed of a steady rotation after it is actuated, is within the range of the pre-set regulated startup time. Based on this result, whether the motor is subjected to an excess load is judged. Accordingly, once the judgment that an abnormality occurs in the card transfer system is made, an erroneous reading of the information or size of the card, which causes a legitimate card medium inserted into the card insertion port by a customer to be judged as a fraudulent card, can be corrected. Hence, the correct judgment that the card transfer system is in abnormal conditions can be made.

### BRIEF DESCRIPTION OF THE DRAWINGS

FIG. 1 is a side view schematically illustrating an example of embodiment of the card reader body of the present invention.

FIG. 2 is a functional block diagram illustrating the configuration of the embodiment.

FIG. 3 is a functional block diagram illustrating the configuration of the diagnostic function section of the embodiment.

FIG. 4 is an operation flow chart illustrating the diagnostic process flow of the embodiment.

FIG. 5 is a property graph illustrating the startup time properties in which the motor rotation speed is a function of time.

### DETAILED DESCRIPTION OF THE DRAWINGS

The configuration of the present invention is described herein with reference to the best mode illustrated in the drawings.

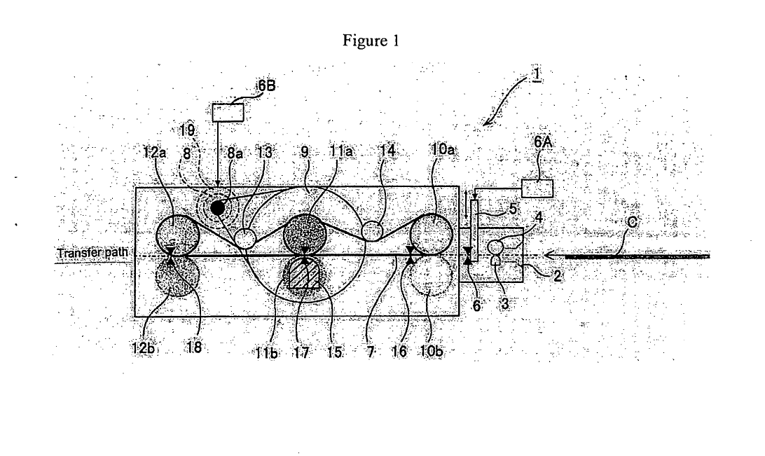

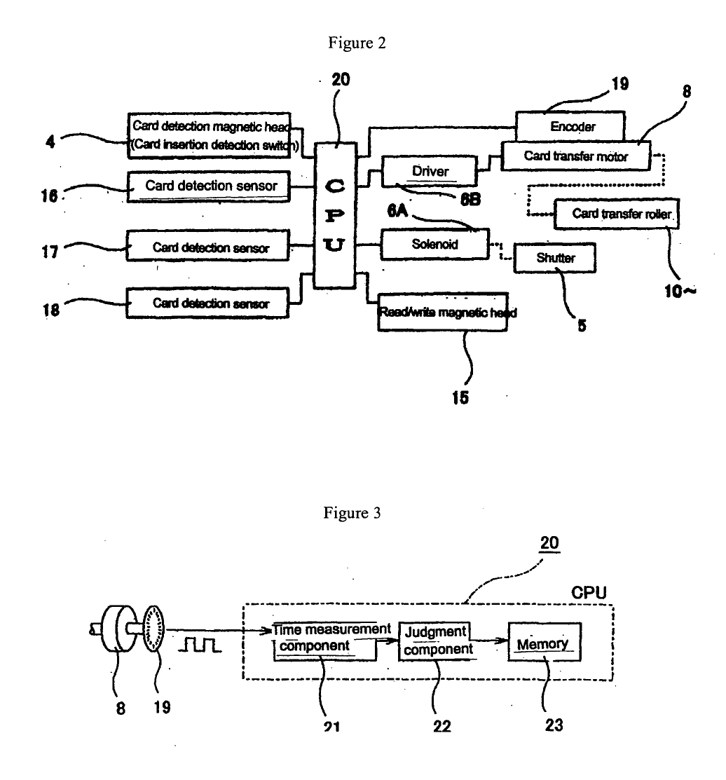

FIGS. 1-5 illustrate an example of embodiment of a card reader. This card reader comprises card reader body 1 and card insertion port 2 for inserting card medium C at the frontal part. In the card transfer path following card insertion port 2, if inserted card medium C is a magnetic card, a pair of magnetic head 3 for detecting a card and pad roller 4 facing a magnetic card above and under the magnetic strip of the recording part are arranged. In addition, shutter 5 is arranged in the card transfer path. If the inserted card medium C is fraudulent, this shutter 5 maintains the closed state such that the fraudulent card is not taken in accordance with the detection result of magnetic head 3 for detecting the card; if it is an appropriate card, shutter 5 opens and allows the card to pass. The card reader further comprises a drive means such as solenoid 6A or the like which opens or closes shutter 5.

In the card transfer path inside shutter 5, transfer belt 7, and motor 8, which is the drive source for conveying this transfer belt 7 in the card transfer direction, as well as motor drive circuit 6B, are provided. Moreover, as illustrated in FIG. 1, on transfer belt 7 arranged at a predetermined position are pulley 9, drive rollers 10a, 11a, and 12a for transfer rollers 10-12, and tension rollers 13 and 14 for controlling belt tensions. These components decelerate the rotational motion of output from output shaft 8a of motor 8 for transferring a card to a preferable rotary speed and transmit it to transfer belt 7. In FIGS., 10b, 11b, and 12b are driven rollers which pair with driving rollers 10a, 11a, and 12a. At a position facing transfer roller 11, read-write magnetic head 15 which writes and reads the data recorded on the strip on card medium C is arranged.

At the positions corresponding to transfer rollers 10-12, card sensors 16, 17, and 18 for detecting the passage or presence of card medium C are arranged. The pitch among the sensors is set to be shorter than the length of card medium C; this enables the determination of the card length through detection of, for example, the tip and tail parts of the card. For card detection sensors 16-18, photosensors comprising an emitting element diode and a receiving element diode may be used. Alternatively, a switching means such as a microswitch may be used.

Also, in FIG. 3, encoder 19, the means for detecting rotation speed of the motor is arranged on the same shaft as output shaft 8a of the above motor 8. The card reader comprises CPU 20, the main component of the card reader control system to which rotation pulse signals are sent from encoder 19. This CPU 20 controls time measurement component 21, the time measurement means, and judgment component 22, the judgment means. The card reader of this embodiment can be connected to a host computer (host PC), the higher level apparatus, which is communicable with a control system such as CPU 20. In such a host PC, an initialization command that initializes the card reader operation is stored in advance, so the host PC can be requested to initialize the command to initiate diagnoses for the transfer system of this card reader to see the presence of an abnormality.

Next, the operation of the above-mentioned card reader is described herein. Usually, to operate a card reader, a customer inserts a magnetic card type card medium C such as a credit card or debit card into card insertion port 2 at a shop. As card medium C is inserted, its magnetic strip is first detected by card detection magnetic head 3. If the card medium C is judged as a legitimate card through detection of its magnetic strip, the resulting signal actuates solenoid 6 to open shutter 5. Opening of shutter 5 enables the customer to further insert card medium C to the deep end. Then, motor 8 is turned on and its rotary motion is transmitted from output shaft 8a to pulley 9, conveyer belt 7, and the like, to rotate drive rollers 10a, 11a, and 12a in the positive direction such that card medium C is conveyed to the position where it is read and written by magnetic head 15. After a required card transaction is completed, the rotary motion of motor 8 is inverted, causing conveyer belt 7 to rotate via drive rollers 10a, 11a, and 12a. Card medium C is thus ejected from card insertion port 2 to be returned to the customer.

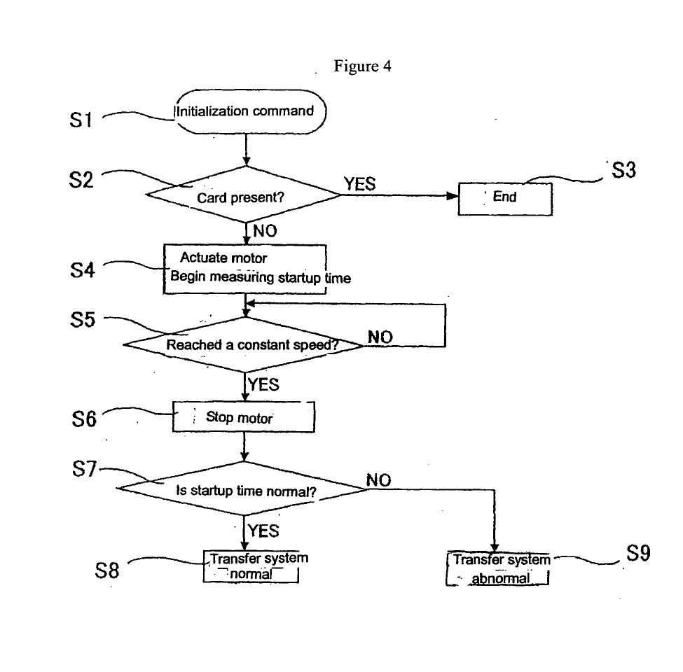

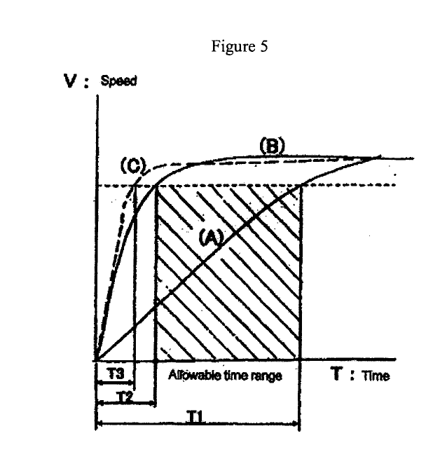

At financial institutions such as banks, such a card reader can be tested for an abnormality diagnosis during the non-business hours on a regular or as needed basis. FIG. 4 is an operation flow chart illustrating the abnormality diagnostic process flow. The initialization command is requested to an upper level host PC and the like and received, when processing of the abnormality diagnostic program begins (Step: S1). Card detection sensors 16-18 are turned on. Detection signals from the sensors provide current status information such as whether card medium C is left on the card transfer path in the card reader, whether the card is present, or where the card is.

In step S2, if a card is detected (Yes), either the card medium C left in the card reader is removed to restart the process or the diagnostic test is terminated (Step: S3). If the absence of the card is confirmed (No) in Step S2, motor 8 is actuated and rotated in a positive direction in the absence of card or any load required for transferring the card. Motor rotation speed V expressed by rotation per minute (rpm) is encoded by encoder 19, and rotation pulse signals are sent to CPU 20. Time measurement component 21, which counts the received rotation pulses, starts measuring the actual startup time, which is the time required for a motor rotation speed V to reach a steady speed in which revolutions are constant after the motor is turned on (Step: S4).

If a card transfer system is in normal conditions, the time required for motor rotation speed V to reach about a steady speed at a constant revolution after actuation is empirically obtained in advance and stored in memory 23. Now, this is expressed by two types of curves labeled A, B in FIG. 5 and named as the “regulated startup property.” In A, one of the regulated startup properties, the regulated time required for motor rotation speed V to reach about a steady speed of constant revolutions is T1. In B, the other regulated startup regulation property, the regulated startup time is T2; this figure shows that T2 spends less time for startup than T1 after the motor is turned on. The duration from T1 (upper limit) to T2 (lower limit) of regulated startup is defined as the allowable range (diagonally shaded area in FIG. 5) of the startup cited in the present invention and can be stored in memory 23 in advance.

In contrast with A and B, the measurement result of this abnormality diagnostic test is expressed by a curve labeled C in the figure and is called the “actual startup property.” In the case of this actual startup property C, the actual startup time, which is the time required for a motor rotation speed V to reach a constant steady speed, is T3; this is shown as an example in which the motor rotation speed achieves its startup in less time and faster than the previously described regulated startup time T2.

In Step S5, motor 8 keeps rotating until its rotation speed V reaches a steady speed at a constant revolution. If motor 8 reaches a steady speed (Yes) at a constant revolution, motor 8 is turned off (Step: S6). Judgment component 22 reads out from memory 23 the allowable range of time between T1 and T2, the regulated startup times of regulated startup properties A and B respectively. It also compares the allowable range with T3, which is the actual startup time of actual startup property C obtained from this measurement. Judgment component 22 further judges whether this actual startup time T3 is within or outside of the allowable range of time between regulated startup times T1 and T2. In the example shown in FIG. 5, the condition satisfies T2>T3. The motor rotation speed V increases so quickly and it takes a short time to reach a steady speed at a constant revolution. One of the reasons why the motor speeds up without delay may be that, for example, transfer belt 7 of the card transfer system is broken and less load is applied to motor 8.

Furthermore, in the case of T3>T1 in which actual startup time T3 exceeds regulated startup time T1, an abnormality may have occurred in any of the components of the card transfer system. As a result, a large load may be applied to motor 8. For example, dust or contaminated lubricant may be deposited around the rotary shaft of transfer rollers 10-12 of the card transfer system, thereby increasing rotational friction.

Based on the judgment method described above, judgment component 22 judges whether the startup time immediately after motor 8 is actuated is normal (Step: S7). If it judges “normal” (Yes), the message that “the card transfer system is in the normal condition” is sent and notified by means of displaying it on a monitor screen or the like, which is the display means named in the present invention of an upper level apparatus such as a host PC (Step: S8). If judgment component 22 judges “abnormal” (No) in step S7, the recognition that an abnormality occurs in the card transfer system is reported to a host PC or the like (Step: S9).

Under abnormal conditions, the data can be stored in a memory as a machine history of the card reader, a message communicating the need for maintenance services such as repair can be sent, and termination of the machine's card transaction can be commanded.

On the other hand, another mode of embodiment can carry out the abnormality diagnosis as follows. In the above embodiment, the startup time upon actuation of the motor is observed. Instead, the actual drive-off time is monitored to see if it remains within the allowable range of the regulated drive-off time stored in memory 23 in advance by sending a turn-off signal to motor 8 being driven and by measuring the actual drive-off time, which is the time required for output shaft 8a to substantially come to a complete stop.

In other words, if motor 8 reaches a steady state rotation speed of a constant revolution, the motor is kept operating while an off signal is sent to motor drive circuit 6B to turn off motor 8. When too much or too little load is applied to motor 8, the time required for output shaft 8a comes to a complete stop for each situation deviates from the case where a normal load is applied to motor 8. As a result, judgment component 22 reads out the regulated drive-off time from memory 23 and compares it with the actual drive-off time measured at this time, then judges whether the actual drive-off time is within the allowable range of the regulated drive-off time. Accordingly, whether the card transfer system is in abnormal conditions is judged.

An example of preferable modes of embodiments is described above. However, the present invention is not limited to these modes of embodiment. Any modification can be made to the embodiment as long as it remains within the spirit of the present invention. For example, in this embodiment, described is an example in which the initialization command is received from an upper level apparatus such as a host PC and the like and the abnormality diagnostic test is executed based on the diagnostic program initialized by the initialization command. Alternatively, a program can also be stored and executed, in which the card reader itself self-diagnosis an abnormality of the card transfer system without receiving the initialization command from a host PC and the like.

In another embodiment, whether the abnormality diagnostic program through the initiation command from a host PC is used or the abnormality self-diagnostic program of a card transfer system embedded in a card reader itself is used, if it is judged that the card transfer system is in abnormal conditions, an alarm lamp such as an LED lamp arranged in an appropriate place in the card reader may be lit up or blinked to communicate that the card reader's transaction will be stopped temporarily. Alternatively, the abnormal information may be received by the host PC side so as to report a temporary halt of the card transaction in the card reader.

Furthermore, this embodiment is described using a magnetic card type card reader in which magnetic head 15 is used to readout or write the information recorded on the magnetic strip of card medium C. However, this embodiment may be applied to a motor driven transfer type card reader used for an IC card.

We claim:

1. A card reader in which a card transfer system operated by motor-driven rotations transfers a card medium to a given position where card data is readout and written comprises:
a time measurement means for measuring the startup time, which is the time it takes for said motor to reach a steady rotation speed after it is turned on;
a judgment means for judging whether said card transfer system is operating under normal or abnormal conditions by way of comparing a regulated startup time set in advance with said actual startup time obtained from said time measurement means to detect if said actual startup time remains within the allowable range of said regulated startup time, and by way of further deciding if said motor is operated under a normal or abnormal load.

2. The card reader according to claim 1, wherein a control system comprises said time measurement means and said judgment means, and communicably connected to an upper level apparatus, and judges whether said motor and said card transfer system operate in abnormal conditions in accordance with an abnormality diagnostic program initialized by the initialization command received from said upper level apparatus.

3. The card reader according to claim 1, further comprises a memory for memorizing said regulated startup time and storing the judgment results on normality or an abnormality of said transfer system as a history, and also comprises a display means for notifying said results by displaying it on a screen.

4. A card reader in which a card transfer system is operated by motor-driven rotations to transfer a card medium to a given position where card data is readout and written comprises:
a time measurement means for measuring the time required for the motor output shaft to stop rotating after said motor drive is turned off as the actual drive-off time; and
a judgment means for judging if said transfer system is operating under normal or abnormal conditions by way of comparing a predetermined regulated drive-off time with said actual drive-off time obtained from said time measurement means to detect if said actual drive-off time remains within the allowable range of said regulated drive-off time and by way of deciding if said motor is operating at a normal load or abnormal load.
